(19) United States
(12) Patent Application Publication
(10) Pub. No.: US 2016/0116913 A1
(43) Pub. Date: Apr. 28, 2016

(54) AUTONOMOUS VEHICLE ENVIRONMENT DETECTION SYSTEM

(71) Applicant: James E. Niles, New York, NY (US)

(72) Inventor: James E. Niles, New York, NY (US)

(21) Appl. No.: 14/521,866

(22) Filed: Oct. 23, 2014

(51) Int. Cl. G05D 1/00; G01N 35/00; G01N 1/22

(52) U.S. Cl. CPC G05D 1/0061; G01N 1/2273; G01N 35/00

(57) ABSTRACT

An autonomous vehicle environment detection method, for use by an autonomous vehicle having autonomous features for allowing a destination to be set by a user and then piloting the vehicle to that destination without human intervention by the user. Environmental sensors, which may be contained in or around the vehicle, or in a portable electronic device possessed and carried by the user, perform a sniff test prior to, and during automated vehicle operation. If hazardous materials are detected that indicate the presence of a weapon of mass destruction, autonomous features are disabled while manual operation of the vehicle may be permitted.

### TECHNICAL FIELD

The present disclosure relates generally to autonomous vehicles that are configured to detect dangerous conditions and respond appropriately. More particularly, the present disclosure relates to a system for automatically detecting the possible presence of a WMD (weapon of mass destruction), and disabling certain automated features in response thereto.

### BACKGROUND

For more than a decade, the threat of domestic terrorism has proven itself to be significant and real, and has become an accepted cause for concern by all entities public and private. Taking steps to prevent terrorism has taken a critical role in our everyday preoccupation with safety and preserving human life.

As technology develops, we are cognizant of the fact that our technology has been previously used against us—used to harm us. Accordingly, with every new technological development we must unfortunately consider how it might create new vulnerabilities and new opportunities for terrorists.

As long as automobiles have existed, so has the notion of an autonomous car or vehicle. An autonomous vehicle, also known as a driverless car, driver-free car, self-driving car or robot car, is a vehicle capable of fulfilling the human transportation capabilities of a traditional car. It is capable of sensing its environment and navigating without human input.

As the possibility of such a car moves ever closer to reality, we are faced with philosophical questions about the propriety of placing a machine—lacking in human judgement and human values—in control of such a potentially dangerous instrument. As a consequence, while the technology is currently ripe for driverless vehicles, perhaps the only barrier to them becoming available now is the remaining question of safety.

When considering the safety of these vehicles, the primary focus is how such vehicles might inadvertently cause harm to persons or property. The focus is rarely placed on how the vehicles might be intentionally used to harm others. Due to terrorism concerns, however, we must consider that possibility as well and take steps to prevent driverless vehicles from being used intentionally to cause devastation.

As a result, we must consider the possibility that an autonomous vehicle might be loaded with an explosive, WMD, or other hazard by a terrorist, and sent off unmanned to a target location. While such an attack might be possible with a manned vehicle, allowing a terrorist to execute an attack without harming himself dramatically increases the possible extent and quantity of such attacks.

While these units may be suitable for the particular purpose employed, or for general use, they would not be as suitable for the purposes of the present disclosure as disclosed hereafter.

In the present disclosure, where a document, act or item of knowledge is referred to or discussed, this reference or discussion is not an admission that the document, act or item of knowledge or any combination thereof was at the priority date, publicly available, known to the public, part of common general knowledge or otherwise constitutes prior art under the applicable statutory provisions; or is known to be relevant to an attempt to solve any problem with which the present disclosure is concerned.

While certain aspects of conventional technologies have been discussed to facilitate the present disclosure, no technical aspects are disclaimed and it is contemplated that the claims may encompass one or more of the conventional technical aspects discussed herein.

### BRIEF SUMMARY

An aspect of an example embodiment in the present disclosure is to provide a detection system that prevents the intentional misuse of an autonomous vehicle to deliver dangerous cargo. Accordingly, upon detection of predetermined hazardous materials, certain features of the vehicle are disabled.

It is another aspect of an example embodiment in the present disclosure to provide a detection system that prevents the misuse of an autonomous vehicle as an unmanned carrier of a weapon of mass destruction (WMD) to a target location. Accordingly, upon performing a sniff test and detecting a possible WMD, autonomous features of the vehicle are disabled.

It is yet another aspect of an example embodiment in the present disclosure to provide a detection system that works in cooperation with a portable electronic device, the portable device for authorizing use of the vehicle. The portable electronic device having WMD sensors for performing a sniff test which is communicated to the vehicle.

It is still another aspect of an example embodiment in the present disclosure to provide a vehicle which helps prevent harm to the user and other occupants. Accordingly, when the sniff test detects carbon monoxide, the vehicle may be fully disabled.

Accordingly, the present disclosure describes an autonomous vehicle environment detection method, for use by an autonomous vehicle having autonomous features for allowing a destination to be set by a user and then piloting the vehicle to that destination without human intervention by the user. Environmental sensors, which may be contained in or around the vehicle, or in a portable electronic device possessed and carried by the user, perform a sniff test prior to, and during automated vehicle operation. If hazardous materials are detected that indicate the presence of a weapon of mass destruction, autonomous features are disabled while manual operation of the vehicle may be permitted.

The present disclosure addresses at least one of the foregoing disadvantages. However, it is contemplated that the present disclosure may prove useful in addressing other problems and deficiencies in a number of technical areas. Therefore, the claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

### BRIEF DESCRIPTION OF THE DRAWINGS

In the drawings, like elements are depicted by like reference numerals. The drawings are briefly described as follows.

FIG. 1 is a diagrammatic perspective view, depicting an example embodiment of an autonomous vehicle environment detection system, in accordance with the present disclosure.

FIG. 2 is a side elevational view of an example embodiment of a vehicle having vehicle mounted sensors, indicating possible sensor locations, in accordance with the present disclosure.

FIG. 3 is a flow diagram, illustrating exemplative steps for initiating vehicle use in accordance with principles of the present disclosure.

FIG. 4 is a diagrammatic perspective view, illustrating an example embodiment, wherein authorization involves a portable electronic device.

FIG. 5 is a flow diagram, illustrating exemplative steps for authorizing vehicle use with the portable electronic device.

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete and fully conveys the scope of the present disclosure to those skilled in the art.

### DETAILED DESCRIPTION OF THE PREFERRED EMBODIMENTS

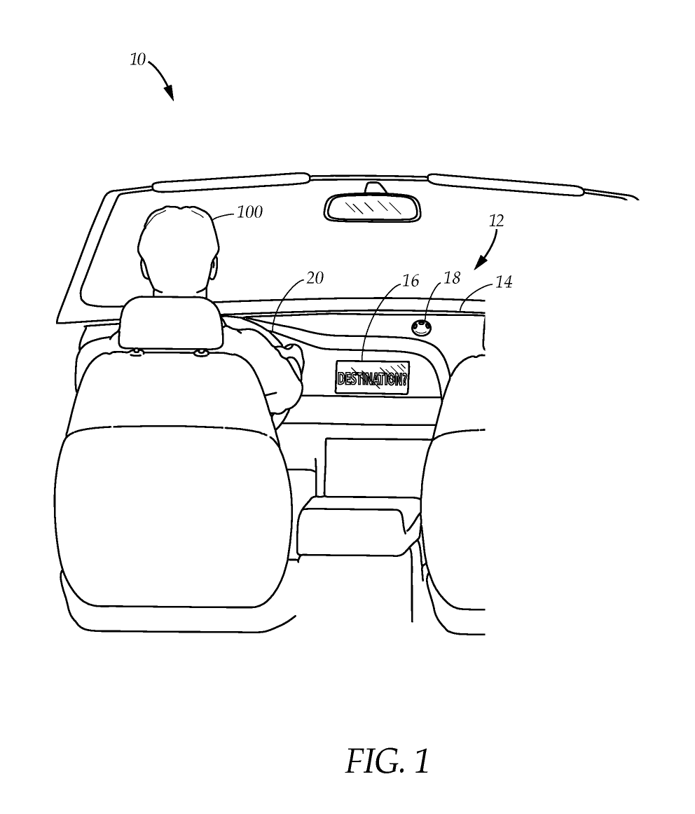

FIG. 1 illustrates an autonomous vehicle 10 having a passenger compartment 12, wherein a user 100 is seated in the passenger compartment 12. The passenger compartment has a dashboard 14, a dashboard display 16 and an environment sensing module 18. The dashboard display 16 allows the user to select a variety of autonomous vehicle features, including accessing a guidance system to select a destination for the vehicle 10. In accordance with principles of autonomous, self-driven vehicles, when a destination is selected, and when the autonomous features are enabled, the vehicle 10 can pilot itself to the destination with no or minimal intervention by the user. A steering wheel 20 is also provided at the dashboard, along with other manual controls. The steering wheel 20 allows manual operation of the vehicle 10 when autonomous controls are disabled.

The environmental sensing module 18 is capable of performing a sniff test and detecting a variety of hazards, including hazardous substances and radiation. The hazardous substances may be airborne hazardous substances and other residue that are detectible by sensors, both presently and prospectively available. In particular, the environmental sensing module 18 is configured for sensing hazardous substances and radiation associated with, and which tend to indicate the presence of WMDs (weapons of mass destruction). The environmental sensing module 18 is also capable of detecting elevated and potentially harmful levels of carbon monoxide.

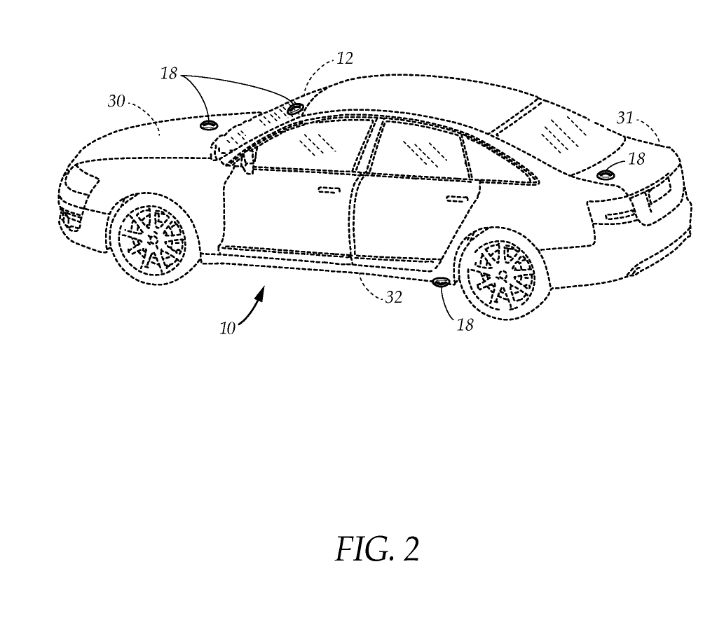

The environmental sensing module 18, may be contained in the passenger compartment 12. Referring now to FIG. 2, however, several environmental sensing modules may be located within and around the vehicle 10. In particular, the vehicle has an engine compartment 30, a cargo compartment 31, and an undercarriage 32. As indicated, the environmental sensing modules 18 may be positioned in the engine compartment 30, in the cargo compartment 31, in the undercarriage 32, as well as in the passenger compartment 12.

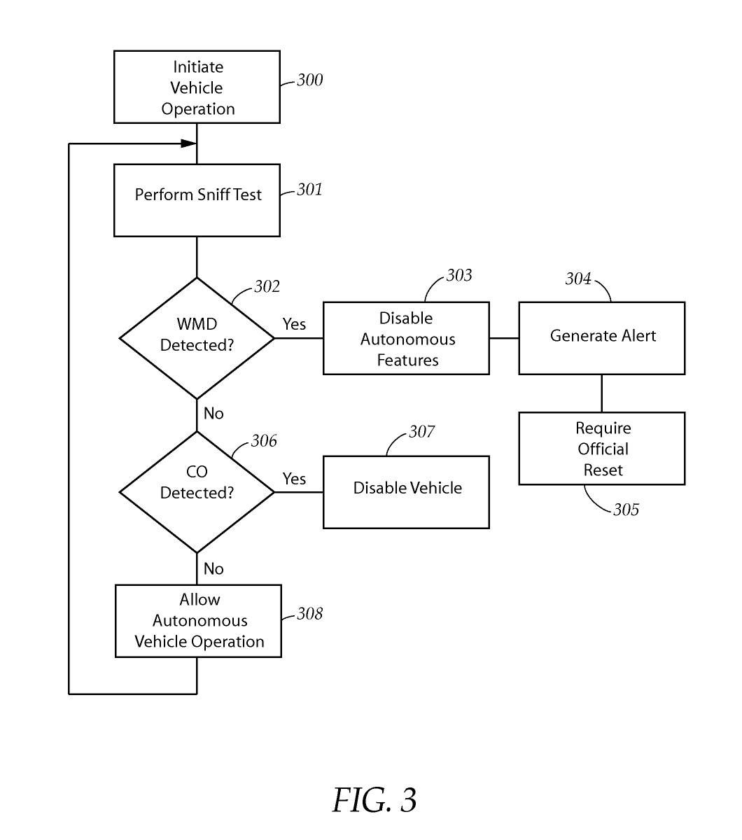

Referring now to FIG. 3, a user initiates vehicle operation 300. Such can be by starting the vehicle, switching on the ignition, activating the guidance system, or even unlocking the vehicle to enter it. At that point, a sniff test is performed 301 to detect hazardous substances in or around the vehicle. If, by the sniff test, the possible presence of a WMD is indicated 302, autonomous features of the vehicle are disabled 303. In addition, the system may generate an alert 304, which may be directed to law enforcement or other officials. Further, following the WMD detection 302, the vehicle may require an official reset 305 from law enforcement, other officials, or authorized vehicle service personal. After the WMD detection 302, the vehicle may be driven manually. Manually driving the vehicle, as described herein, means operating the vehicle in a manner that requires continuous human interaction, such as by operating the steering wheel 20 (FIG. 1). Requiring manual operation avoids the possibility that the vehicle can be sent unmanned to a destination selected on the guidance system.

After the sniff test 301, if WMDs are not detected at 302, but carbon monoxide is detected 306, the vehicle is disabled 307. Disabling the vehicle preferably includes a full shut down of the vehicle, including any possible source of carbon monoxide.

If neither WMDs nor carbon monoxide are detected, the autonomous vehicle operation is allowed 308. Allowing autonomous operation includes allowing the user to enter a destination into the guidance system and have the vehicle pilot itself to that destination without human intervention. While autonomous vehicle operation is allowed, the sniff test 301 is preferably repeated at a predetermined interval, as is WMD detection 302, and carbon monoxide detection 307.

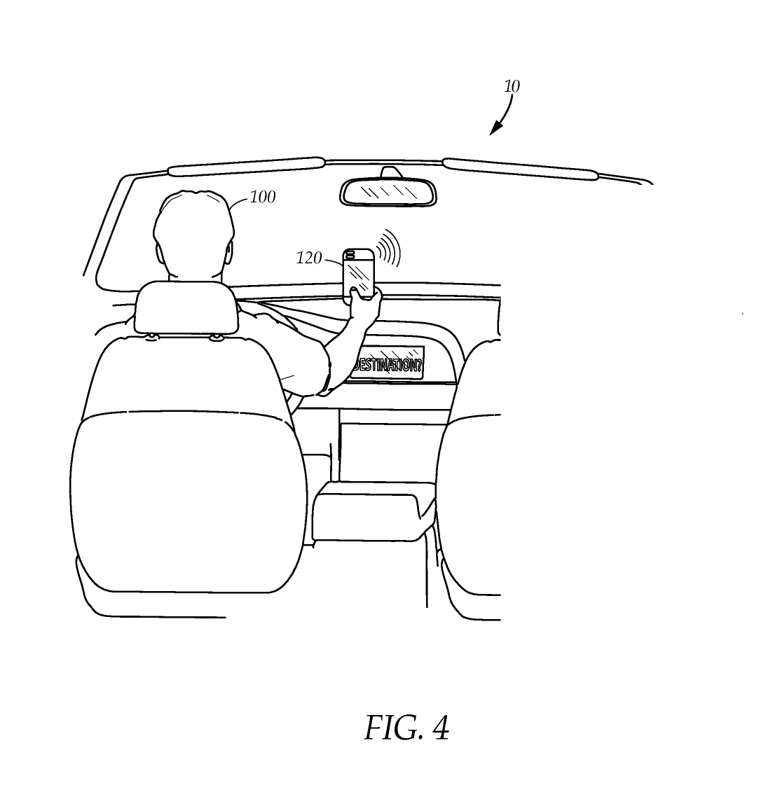

Referring to FIG. 4, initiating use of the vehicle 10 may involve a personal electronic device 120 carried by the user 100. The personal electronic device 120 is small enough to be possessed and carried by the user 100, and contains environmental sensors capable of performing a sniff test for detecting hazardous substances as described herein. The personal electronic device 120 may communicate with the vehicle 10 wirelessly, before and/or after entering the vehicle 10. Accordingly the vehicle 10 may have a short range communication transceiver, capable of communicating with portable electronic devices of the user 100. Such communication may take place via a communication protocol, such as BLUETOOTH, or through other methods of short range communication.

Initially, using the short range communication transceiver, the portable electronic device 120 connects with the vehicle 10. Then, through appropriate handshaking protocols, communication is established between the portable electronic device 120 and the vehicle 10. Such authorization may include “pairing”, such as commonly performed between BLUETOOTH devices, and/or any other necessary steps on the part of the devices and user to enable the exchange of information sufficient for the purposes of the present disclosure.

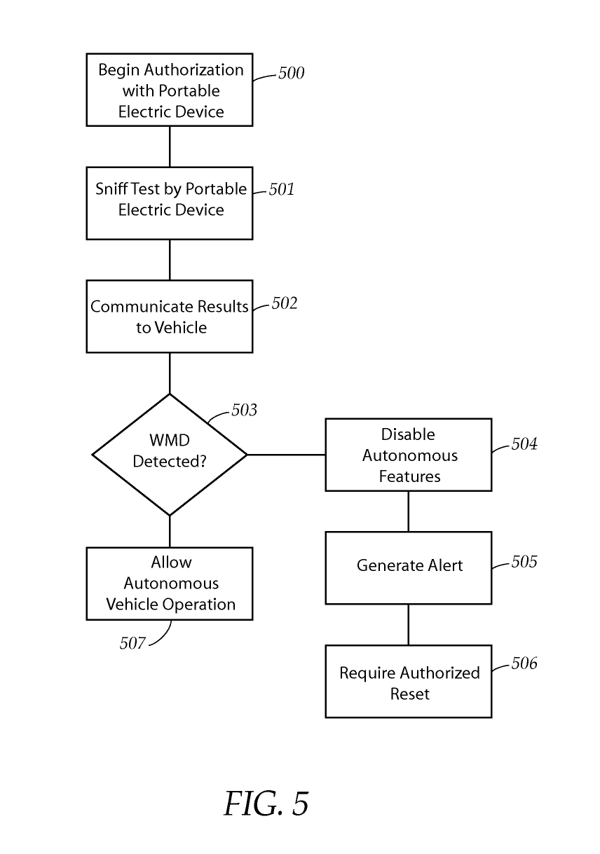

Referring to FIG. 5, the portable electronic device 120 (FIG. 4) is used to authorize use of the vehicle. Once the authorization using the portable electronic device has begun 500, a sniff test is performed by the portable electronic device 501, and results of the sniff test are communicated by the portable electronic device to the vehicle 502. If it materials consistent with a WMD is detected 503, autonomous features of the vehicle are disabled 504, an alert may be generated 505 and sent to law enforcement or other officials, and an authorized reset may be required 506. If a WMD is not detected, autonomous operation 507 is permitted. Of course, during vehicle operation the sniff test 501 may be repeated. Also, like in FIG. 3, part of the steps may include determining if carbon monoxide is detected, and disabling the vehicle in response thereto. The portable electronic device may be a dedicated device—intended specifically for use in authorizing use of the vehicle. The portable electronic device may also be another device, such as a smartphone, which contains application programming for carrying out the authorization process, and has the environmental sensors either built in or attached as an accessory thereto.

It is understood that when an element is referred hereinabove as being “on”, “attached”, or “connected to” another element, it can be directly on, attached, or connected to the other element or intervening elements may be present therebetween.

In conclusion, herein is presented an autonomous vehicle environment detection system. The disclosure is illustrated by example in the drawing figures, and throughout the written description. It should be understood that numerous variations are possible, while adhering to the inventive concept. Such variations are contemplated as being a part of the present disclosure.

What is claimed is:

1. An environment detection method, for use in a vehicle designed for the purpose of carrying human passengers, said vehicle having features for allowing a destination to be set by a human user who is physically located within said vehicle for autonomous operation of said vehicle to that destination without further human intervention by the user, comprising the steps of:
manually setting said vehicle for autonomous operation;
detecting the presence of a hazardous material in or near the vehicle during autonomous operation by performing a sniff test by a detector carried by or within the vehicle;
automatically disabling the autonomous features and operation of the vehicle in response to the detection of said hazardous material in or near the vehicle; and
automatically enabling said vehicle to be operated manually by said human user within the vehicle upon said detection of said hazardous material.

2. (canceled)

3. The environment detection method as recited in claim 1, wherein the vehicle has a steering wheel, and wherein the step of allowing the vehicle to be operated manually further comprises operating the steering wheel.

4. The environment detection method as recited in claim 3, wherein the step of disabling the autonomous features further comprises requiring an authorized manual reset before re-enabling the autonomous features.

5. The environment detection method as recited in claim 4, further comprising disabling the vehicle when said detected hazardous material is carbon monoxide.

6. The environment detection method as recited in claim 1, wherein in the step of disabling the autonomous features of said vehicle in response to the detection of a hazardous material in or near the vehicle, includes detection by said detector of substances indicative of weapons of mass destruction.

7. (canceled)

8. The environment detection method as recited in claim 6, wherein the vehicle has a steering wheel, and wherein the step of allowing the vehicle to be operated manually further comprises operating the steering wheel.

9. The environment detection method as recited in claim 8, wherein the step of disabling the autonomous features further comprises requiring an authorized manual reset before re-enabling the autonomous features.

10. The environment detection method as recited in claim 9, further comprising disabling the vehicle when said detected hazardous material is carbon monoxide.

11. The environment detection method as recited in claim 1, further comprising using a portable electronic device operated by the human user, the portable electronic device having sensors for detecting hazardous materials, and wherein the step of detecting the presence of hazardous materials near the vehicle further comprises performing a sniff test by the portable electronic device.

12. The environment detection method as recited in claim 11, wherein the step of detecting the presence of hazardous materials near the vehicle further comprises wirelessly communicating results of the sniff test from the portable electronic device to the vehicle.

13. An environment detection method for use by a passenger vehicle designed for conveyance of human passengers having autonomous operating features for allowing a destination to be set by a human user located within said vehicle for autonomous operation of said vehicle to that destination without further human intervention by the human user, comprising the steps of:
setting said vehicle for autonomous operation;
using a portable electronic device in the possession of said human user, said portable electronic device having sensors for detecting hazardous materials;
detecting the presence of a hazardous material near the vehicle during autonomous operation by performing a sniff test by the portable electronic device; and
performing one of:
a) automatically disabling the autonomous features in response to the detection of a hazardous material near the vehicle, and
b) allowing continued autonomous operation of the vehicle in response to not detecting hazardous materials near the vehicle.

14. The environment detection method as recited in claim 13, wherein the step of allowing the autonomous operation further comprises entering a destination by the human user, and autonomously operating said vehicle to the destination without further human intervention.

15. The environment detection method as recited in claim 13, wherein in the step of disabling the autonomous features and operation of said vehicle is performed in response to the detection of a hazardous material near the vehicle, which is a substance indicative of weapons of mass destruction.

16. The environment detection method as recited in claim 13, further comprising automatically disabling the vehicle when the hazardous material detected is carbon monoxide.
